(19) United States
(12) Patent Application Publication
(10) Pub. No.: US 2011/0074283 A1
(43) Pub. Date: Mar. 31, 2011

(54) SILICON PHOTOMULTIPLIER TUBE

(76) Inventors: Sung Yong AN, Gyunggi-do (KR); Koung Soo KWON, Gyunggi-do (KR); Chae Dong GO, Gyunggi-do (KR)

(21) Appl. No.: 12/614,409

(22) Filed: Nov. 7, 2009

(30) Foreign Application Priority Data
Sep. 28, 2009 (KR) 10-2009-0091859

(51) Int. Cl. H01J 43/18

(52) U.S. Cl. 313/533

(57) ABSTRACT

Disclosed herein is a silicon photomultiplier tube, including: a first type silicon substrate; a cell, each including a first type epitaxial layer formed on the first type silicon substrate, a first type conductive layer formed on the first type epitaxial layer, and a second type conductive layer formed on the first type conductive layer; a separating element located between the cell and a cell adjacent to the cell to separate the cells from each other; and an antireflection coating layer formed on a top surface of the second type conductive layer and an inner wall of the separating element, wherein any one of the first type conductive layer and the second type conductive layer is formed in a plurality of rows.

### CROSS REFERENCE TO RELATED APPLICATION

This application claims the benefit of Korean Patent Application No. 10-2009-0091859, filed Sep. 28, 2009, entitled “Silicon Photomultiplier”, which is hereby incorporated by reference in its entirety into this application.

### BACKGROUND OF THE INVENTION

1. Technical Field

The present invention relates to a silicon photomultiplier tube.

2. Description of the Related Art

A photodetector, serving to receive light and then convert the light into electrical signals, is used in the fields of image pickup devices, medical appliances, national defenses, single photon detection and high-energy physics.

When a photodetector is used as a high-performance radiation sensor, the photodetector must be sensitive to low irradiance level and be able to acquire information of a single photon. Generally, a vacuum tube type photomultiplier tube (PMT) is chiefly used as a single photon detector. In addition to this, a semiconductor type PIN photodiode, an Avalanche photodiode, a Giger mode Avalanche photodiode and the like may be used as a single photon detector.

The commonly-used vacuum tube type photomultiplier tube (PMT) is problematic in that its volume is large, a high voltage of 1 kV or more must be used, and it is relatively expensive. Further, since the photomultiplier tube is influenced by a magnetic field, there is a problem in that it cannot be used in an apparatus which has a strong magnetic field, for example, a magnetic resonance imaging (MRI) machine.

### SUMMARY OF THE INVENTION

Accordingly, the present invention has been made to solve the above-mentioned problems, and the present invention provides a silicon photomultiplier tube which uses a low voltage and which is not influenced by a magnetic field.

Further, the present invention provides a silicon photomultiplier tube including to separating elements and guard rings formed between adjacent cells.

Further, the present invention provides a silicon photomultiplier tube which can increase the efficiency of the detection of short-wavelength light because any one of a first type conductive layer and a second type conductive layer has a plural array structure.

An aspect of the present invention provides a silicon photomultiplier tube, including: a first type silicon substrate; a cell, each including a first type epitaxial layer formed on the first type silicon substrate, a first type conductive layer formed on the first type epitaxial layer, and a second type conductive layer formed on the first type conductive layer; a separating element located between the cell and a cell adjacent to the cell to separate the cells from each other; and an antireflection coating layer formed on a top surface of the second type conductive layer and an inner wall of the separating element, wherein any one of the first type conductive layer and the second type conductive layer is formed in a plurality of rows.

The antireflection coating layer may be made of any one selected from among polysilicon, silicon nitride (Si₃N₄), indium tin oxide (ITO), a mixture of polysilicon and indium tin oxide, and a mixture of polysilicon and silicon nitride, and may have a thickness of 20˜100 nm.

The first type silicon substrate may have a doping agent concentration of 10¹⁷˜10²⁰cm⁻³.

The first type epitaxial layer may have a doping agent concentration of 10¹⁴˜10¹⁸ cm⁻³ and a thickness of 3˜10 μm.

The first type conductive layer may have a doping agent concentration of 10¹⁵˜10¹⁸ cm⁻³, and the second type conductive layer may have a doping agent concentration of 10¹⁸˜10²⁰ cm⁻³.

The silicon photomultiplier tube may further include: a voltage divider bus formed on the antireflection coating layer to supply a voltage to the second type conductive layer; and a silicon resistor formed on the antireflection coating layer to connect the second type conductive layer with the voltage divider bus.

The silicon resistor may have a resistance of 1 kΩ˜100 MΩ.

The silicon photomultiplier tube may further include: an insulating material charged in the separating element.

The insulation material may be any one selected form among polyimide, polyester, polypropylene, polyethylene, ethylene vinyl acetate (EVA), acrylonitrile styrene acrylate (ASA), poly methyl methacrylate (PMMA), acrylonitrile butadiene styrene (ABS), polyamide, polyoxymethylene, polycarbonate, modified polyphenylene oxide (PPO), polybutylene terephthalate (PBT), polyethylene terephthalate (PET), polyester elastomer, polyphenylene sulfide (PPS), polysulfone, polyphthalic amide, polyether sulfone (PES), poly amide imide (PAI), polyether imide, polyether ketone, liquid crystal polymer, polyarylate, polytetrafluoroethylene (PEFE), polysilicon and mixtures thereof.

The silicon photomultiplier tube may further include: a guard ring formed on an outer wall of the separating element.

The guard ring may be doped into a second type guard ring, and may have a doping agent concentration of 10¹⁴˜10¹⁸ cm⁻³.

The guard ring may be formed to entirely surround an outer wall of the separating element.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a silicon photomultiplier tube according to a first embodiment of the present invention;

FIG. 2 is a sectional view showing a silicon photomultiplier tube according to a second embodiment of the present invention;

FIG. 3 is a sectional view showing a silicon photomultiplier tube according to a third embodiment of the present invention;

FIG. 4 is a graph showing the results of simulating the light detection efficiency of the silicon photomultiplier tube according to the third embodiment of the present invention;

FIG. 5 is a sectional view showing a silicon photomultiplier tube according to a fourth embodiment of the present invention; and

FIG. 6 is a sectional view showing a silicon photomultiplier tube according to a fifth embodiment of the present invention.

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

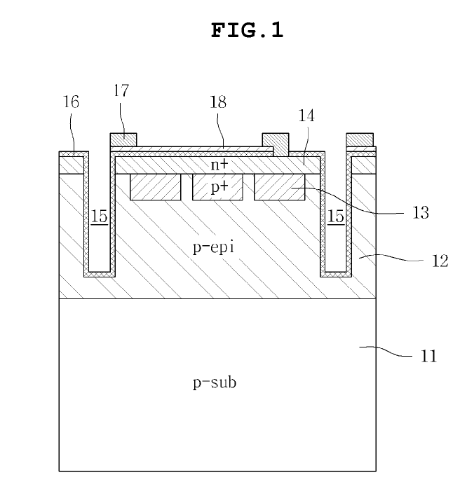

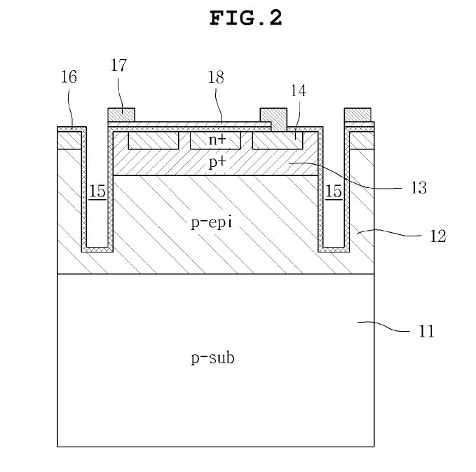

FIG. 1 is a sectional view showing a silicon photomultiplier tube according to a first embodiment of the present invention, and FIG. 2 is a sectional view showing a silicon photomultiplier tube according to a second embodiment of the present invention. Hereinafter, silicon photomultiplier tubes according to the first and second embodiments of the present invention will be described in detail with reference to FIGS. 1 and 2.

Referring to FIG. 1, a silicon photomultiplier tube includes a first type silicon substrate 11; a plurality of cells, each composed of a first type epitaxial layer 12, a first type conductive layer 13 and a second type conductive layer 14; separating elements 15 for separating adjacent cells; and an antireflection coating layer 16 formed on the top surface of the second type conductive layer 14 and the inner walls of the separating elements 15.

Here, the terms “first type and second type” are used to designate “P-type” and “N-type” which are classified by the kind of doping materials. In FIG. 1, the first type designates P-type, and the second type designates N-type. However, the silicon photomultiplier tube shown in FIG. 1 is only an example of a silicon photomultiplier tube. Silicon photomultiplier tubes in which the first type designates N-type and the second type to designates P-type may also be implemented. For the convenience of explanation, a silicon photomultiplier tube in which the first type designates P-type and the second type designates N-type will be described as an example.

The first type silicon substrate 11 is a base of the silicon photomultiplier tube, and has a doping agent concentration of 10¹⁷˜10²⁰ cm⁻³. For this reason, a first type epitaxial layer can be grown on the first type silicon substrate 11.

A plurality of cells is formed on the first type silicon substrate 11. Each cell includes a first type epitaxial layer 12, a first type conductive layer 13 and a second type conductive layer 14.

First, the first type epitaxial layer 12 is formed on the first type silicon substrate 11. The first type epitaxial layer 12 may have a thickness of 3˜10 μm. Further, the first type epitaxial layer 12 may have a doping agent concentration of 10¹⁴˜10¹⁸ cm⁻³.

Further, the first type conductive layer 13 is formed on the first type epitaxial layer 12. The first type conductive layer 13 may have a doping agent concentration of 10¹⁵˜10¹⁸ cm⁻³.

Further, the second type conductive layer 14 is formed on the first type conductive layer 13. The second type conductive layer 14 may have a doping agent concentration of 10¹⁸˜10²⁰ cm⁻³.

However, the doping agent concentration of each of the first type epitaxial layer 12, the first type conductive layer 13 and the second type conductive layer 14 may be varied.

In this case, a depletion layer is formed between the first type conductive layer 13 and the second type conductive layer 14 due to the occurrence of a P-N junction. The depth of the depletion layer may be 0.3˜0.8 μm. When this thin depletion layer is formed, the electric field near the P-N junction is greatly increased to 10⁵ V/cm, and photomultiplication is also increased.

Further, breakdown voltage can be controlled by adjusting the depth of the depletion layer according to the concentrations of the conductive layers 13 and 14. That is, as the conductive layers 13 and 14 are doped at high concentrations, the depth of the depletion layer is shortened, thus decreasing the breakdown voltage. Since bias voltage is generally formed at above the breakdown voltage, a decrease of breakdown voltage means a decrease of bias voltage.

Therefore, bias voltage can be decreased by controlling the concentration of each of the conductive layers 13 and 14, particularly, the first type conductive layer 13 (for example, the bias voltage can be decreased to 20 V or less). Further, when the bias voltage is decreased, a dark rate, which is the noise of the silicon photomultiplier tube, can also be decreased.

Meanwhile, any one of the first type conductive layer 13 and the second type conductive layer 14 is formed in a plurality of rows. In FIG. 1, the first type conductive layer is formed in three rows. In this case, the first type conductive layer 13 or the second type conductive layer 14 may be formed in two rows or four rows.

Further, as shown in FIG. 2, the silicon photomultiplier tube of the present invention may have a structure in which a second type conductive layer formed in three rows is embedded in a first type conductive layer. The silicon photomultiplier tube having this structure exhibits the same effects as the silicon photomultiplier tube shown in FIG. 1.

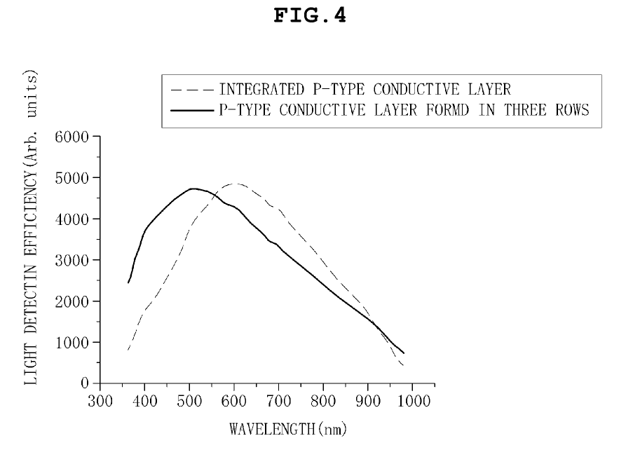

When any one of the first type conductive layer 13 and the second type conductive layer 14 is formed in a plurality of rows, the efficiency of light detection in short wavelength regions can be increased. The detailed description thereof will be described later with reference to FIG. 4.

Meanwhile, the silicon photomultiplier tube includes a plurality of cells and separating elements 15 for separating the cells. Each of the separating elements 15, as shown in FIG. 1, may be a trench. However, the shape of the trench is not limited.

These separating elements 15 serve to prevent the photoelectrons generated by secondary photons of Geiger discharge in cells from infiltrating into a sensitivity range between adjacent cells. Therefore, it is preferred that the space elements 15 reach the first type silicon substrate 11 across the first type epitaxial layer 12.

The silicon photomultiplier tube may further include an antireflection coating layer 16 formed on the top surface of the second type conductive layer 14 and the inner walls of the separating elements 15.

External light is incident on the second type conductive layer 14 and the separating elements 15. In this case, the antireflection coating layer 16 decreases the amount of reflected light to increase the sensitivity of cells, and, owing to the increase in the sensitivity of cells, the efficiency of light detection over a large bandwidth of wavelengths can be increased.

This antireflection coating layer is a silicon oxide layer, and is made of any one selected from among polysilicon, silicon nitride (Si₃N₄), indium tin oxide (ITO), a mixture of polysilicon and indium tin oxide, and a mixture of polysilicon and silicon nitride. The antireflection coating layer may have a thickness of 20˜100 nm.

The silicon photomultiplier tube may further include a voltage divider bus 17 and a silicon resistor 18.

The voltage divider bus 17 is formed on the antireflection coating layer 16 formed on the second type conductive layer 14, and supplies a voltage to the second type conductive layer 14. The voltage divider bus 17 is made of metal such as aluminum.

Further, the silicon resistor 18 is also formed on the antireflection coating layer 16 formed on the second type conductive layer 14, and is connected with the voltage divider bus 17 to supply a voltage to the second type conductive layer 14. This silicon resistor 18 may have a resistance of 1 kΩ˜100 MΩ.

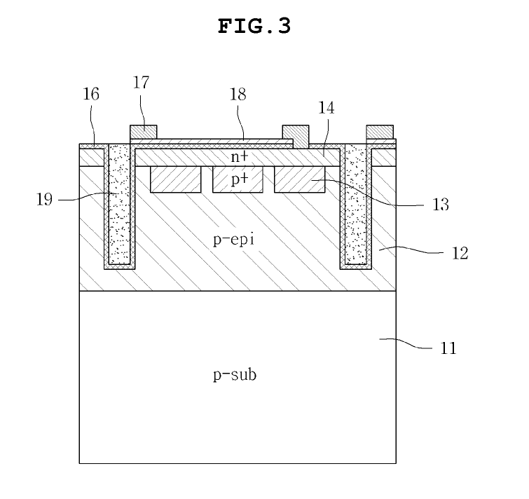

FIG. 3 is a sectional view showing a silicon photomultiplier tube according to a third embodiment of the present invention. Hereinafter, a silicon photomultiplier tube according to the third embodiment of the present invention will be described in detail with reference to FIG. 3. However, detailed description of the constituents the same as those of the silicon photomultiplier tubes described with reference to FIGS. 1 and 2 will be omitted.

As shown in FIG. 3, the silicon photomultiplier tube according to this embodiment may further include an insulating material 19 charged in the separating elements 15. In this embodiment, the separating elements 15 are filled with the insulating material 19, thus providing a silicon photomultiplier tube having a more stable cell structure.

Examples of the insulating material may include polyimide, polyester, polypropylene, polyethylene, ethylene vinyl acetate (EVA), acrylonitrile styrene acrylate (ASA), poly methyl methacrylate (PMMA), acrylonitrile butadiene styrene (ABS), polyamide, polyoxymethylene, polycarbonate, modified polyphenylene oxide (PPO), polybutylene terephthalate (PBT), polyethylene terephthalate (PET), polyester elastomer, polyphenylene sulfide (PPS), polysulfone, polyphthalic amide, polyether sulfone (PES), poly amide imide (PAI), polyether imide, polyether ketone, liquid crystal polymer, polyarylate, polytetrafluoroethylene (PEFE), polysilicon and mixtures thereof.

The insulating material 19 charged in the separating elements, together with the separating elements 15, serves to prevent the photoelectrons generated from adjacent cells from infiltrating into the sensitivity region of other cells.

FIG. 4 is a graph showing the results of simulating the light detection efficiency of the silicon photomultiplier tube according to the third embodiment of the present invention.

The silicon photomultiplier tube having the light detection efficiency shown in FIG. 4 is configured such that a dose of 3*10¹² cm⁻³ is applied to the second type conductive layer 14, a dose of 2*10¹² cm⁻³ is applied to the first type conductive layer 13, the first type epitaxial layer 12 has a doping agent concentration of 2*10¹⁵ cm⁻³, each cell has a width of 30 μm, and the width between adjacent rows in the first type conductive layer 13 formed in three rows is 0.5 μm. From FIG. 4, it can be seen that the light detection efficiency of this silicon photomultiplier tube to short-wavelength light having a wave length of about 500 nm is higher than that of the silicon photomultiplier tube including an integrally-formed first type conductive layer.

Since the silicon photomultiplier tube according to this embodiment is highly efficient at detecting short-wavelength light and then converting it into electrical signals, when blue light is irradiated, the usefulness of the silicon photomultiplier tube according to this embodiment is increased.

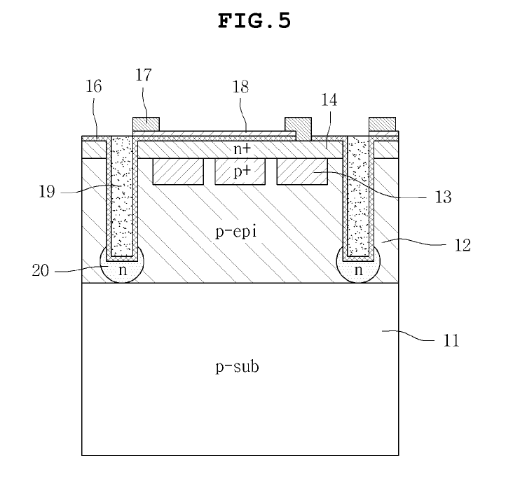

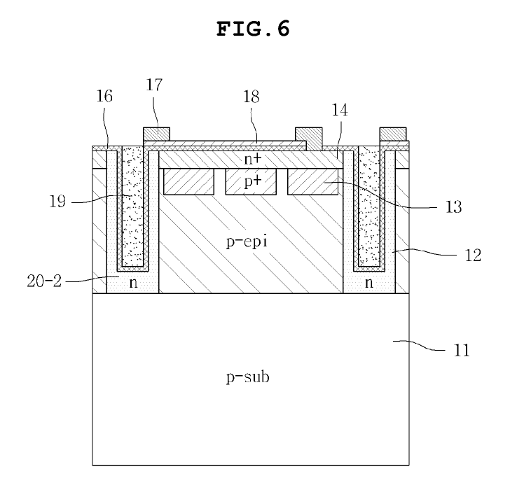

FIG. 5 is a sectional view showing a silicon photomultiplier tube according to a fourth embodiment of the present invention, and FIG. 6 is a sectional view showing a silicon photomultiplier tube according to a fifth embodiment of the present invention. Hereinafter, silicon photomultiplier tubes according to the fourth and fifth embodiments of the present invention will be described in detail with reference to FIGS. 5 and 6. However, detailed description of the constituents the same as those of the silicon photomultiplier tubes described with reference to FIGS. 1 to 3 will be omitted.

As shown in FIG. 5, a silicon photomultiplier tube according to a fourth embodiment of the present invention may further include guard rings 20 formed on the to outer walls of the separating elements 15.

These guard rings 20 are formed into second type guard rings 20 using an implant method after the formation of the separating elements, and each of the second type guard rings 20 has a doping agent concentration of 10¹⁴˜10¹⁸ cm⁻³. These guard rings 20, together with the separating elements 15 and the insulating material 19 charged in the separating elements 15, serves to prevent the photoelectrons generated from adjacent cells from infiltrating into the sensitivity region of other cells.

The guard rings 20 may be formed to partially surround the separating elements. As shown in FIG. 5, the guard rings 20 may be formed to surround the lower ends of the separating elements 15. However, this is only an example, and the guard rings 20 may be formed to partially surround the outer walls of the separating elements 15. Further, the guard rings 20 may be elliptically formed, and may have shapes corresponding to the shapes of the separating elements 15.

As shown in FIG. 6, guard rings 20-2 may be formed to entirely surround the outer walls of the separating elements 15. These guard rings 20-2 can more improve optical separability compared to the guard rings 20 shown in FIG. 5, and can decrease the dark rate which can occur between the separating elements 15.

Since the guard rings 20 and 20-2 are integrated with the separating elements 15, they can provide high optical separability even when the intervals of the separating elements themselves are narrowed, and their sizes can be decreased in a region outside the cells, thus miniaturizing a silicon photomultiplier tube.

In the present invention, for the convenience of explanation, a silicon photomultiplier tube which can detect a single photon was described. However, the silicon photomultiplier tube having the above-mentioned cell structure can be fabricated in the form of an array, so that light detection can be precisely performed even when light is incident on the large area of the silicon photomultiplier tube. Examples of the array may include 2×2, 3×3, 4×4, 8×8, 16×16 and the like.

Further, in the present invention, for the convenience of explanation, a silicon photomultiplier tube including a first type substrate, a first type epitaxial layer formed on the first type substrate, a first type conductive layer formed on the first type epitaxial layer, a second type conductive layer formed on the first type conductive layer and second type guard rings was described as an example. However, a silicon photomultiplier tube having a structure opposite to that of this silicon photomultiplier tube can also be implemented, and can have the same effect as this silicon photomultiplier tube.

As described above, according to the silicon photomultiplier tube of the present invention, any one of the first type conductive layer and the second type conductive layer is formed in a plurality of rows, thus increasing the efficiency of the detection of short-wavelength light.

Further, according to the silicon photomultiplier tube of the present invention, any one of the conductive layers is formed in a plurality of rows, so that uniform conductive layers can be formed, thus increasing light detection efficiency.

Further, according to the silicon photomultiplier tube of the present invention, the depth of a P-N junction is adjusted to decrease breakdown voltage, thus decreasing bias voltage.

Furthermore, according to the silicon photomultiplier tube of the present invention, separating elements, an insulating material charged in the separating elements and guard rings formed on the outer wall of the separating elements decrease light noise, thus allowing the silicon photomultiplier tube to operate more stably.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A silicon photomultiplier tube, comprising:
a first type silicon substrate;
a cell, each including a first type epitaxial layer formed on the first type silicon substrate, a first type conductive layer formed on the first type epitaxial layer, and a second type conductive layer formed on the first type conductive layer;
a separating element located between the cell and a cell adjacent to the cell to separate the cells from each other; and
an antireflection coating layer formed on a top surface of the second type conductive layer and an inner wall of the separating element,
wherein any one of the first type conductive layer and the second type conductive layer is formed in a plurality of rows.

2. The silicon photomultiplier tube according to claim 1, wherein the antireflection coating layer is made of any one selected from among polysilicon, silicon nitride (Si₃N₄), indium tin oxide (ITO), a mixture of polysilicon and indium tin oxide, and a mixture of polysilicon and silicon nitride, and has a thickness of 20˜100 nm.

3. The silicon photomultiplier tube according to claim 1, wherein the first type silicon substrate has a doping agent concentration of 10¹⁷˜10²⁰ cm⁻³.

4. The silicon photomultiplier tube according to claim 1, wherein the first type epitaxial layer has a doping agent concentration of 10¹⁴˜10¹⁸ cm⁻³ and a thickness of 3˜10 μm.

5. The silicon photomultiplier tube according to claim 1, wherein the first type conductive layer has a doping agent concentration of 10¹⁵˜10¹⁸ cm⁻³, and the second type conductive layer has a doping agent concentration of 10¹⁸˜10²⁰ cm⁻³.

6. The silicon photomultiplier tube according to claim 1, further comprising:
a voltage divider bus formed on the antireflection coating layer to supply a voltage to the second type conductive layer; and
a silicon resistor formed on the antireflection coating layer to connect the second type conductive layer with the voltage divider bus.

7. The silicon photomultiplier tube according to claim 6, wherein the silicon resistor has a resistance of 1 kΩ˜100 MΩ.

8. The silicon photomultiplier tube according to claim 1, further comprising: an insulating material charged in the separating element.

9. The silicon photomultiplier tube according to claim 8, wherein the insulation material is any one selected form among polyimide, polyester, polypropylene, polyethylene, ethylene vinyl acetate (EVA), acrylonitrile styrene acrylate (ASA), poly methyl methacrylate (PMMA), acrylonitrile butadiene styrene (ABS), polyamide, polyoxymethylene, polycarbonate, modified polyphenylene oxide (PPO), polybutylene terephthalate (PBT), polyethylene terephthalate (PET), polyester elastomer, polyphenylene sulfide (PPS), polysulfone, polyphthalic amide, polyether sulfone (PES), poly amide imide (PAI), polyether imide, polyether ketone, liquid crystal polymer, polyarylate, polytetrafluoroethylene (PEFE), polysilicon and mixtures thereof.

10. The silicon photomultiplier tube according to claim 1, further comprising: a guard ring formed on an outer wall of the separating element.

11. The silicon photomultiplier tube according to claim 10, wherein the guard ring is doped into a second type guard ring, and has a doping agent concentration of 10¹⁴˜10¹⁸ cm⁻³. 10

12. The silicon photomultiplier tube according to claim 10, wherein the guard ring is formed to entirely surround an outer wall of the separating element.
